(19) United States
(12) Patent Application Publication
(10) Pub. No.: US 2016/0275438 A1
(43) Pub. Date: Sep. 22, 2016

(54) SYSTEM AND COMPUTER PROGRAM PRODUCT FOR COORDINATING AND MONITORING SERVICE PROVIDERS

(71) Applicants: Paul Lawrence Woodring, JR., Carlsbad, CA (US); Val Okolu, West Hollywood, CA (US)

(72) Inventors: Paul Lawrence Woodring, JR., Carlsbad, CA (US); Val Okolu, West Hollywood, CA (US)

(21) Appl. No.: 15/075,028

(22) Filed: Mar. 18, 2016

Related U.S. Application Data
(60) Provisional application No. 62/135,555, filed on Mar. 19, 2015.

(51) Int. Cl. G06Q 10/06; G06F 17/30

(52) U.S. Cl. CPC G06Q 10/063114; G06F 17/30991; G06F 17/30241

(57) ABSTRACT

A system and computer program product for coordinating and monitoring service providers is disclosed which provides an electronic portal accessible by service requesters and service providers. Service requesters may request and hire service providers that are assigned to an event and location to provide services. The progress of services may be monitored remotely. In addition, a safety feature is included which transmits a polling signal to the computing device of the service provider requiring acknowledgment of the polling signal to ensure that an emergency situation has not occurred needing attention. Some embodiments will alert a third party if the service provider has not responded.

### CROSS-REFERENCE TO RELATED APPLICATIONS

This application claims benefit under 35 U.S.C. §119(e) of U.S. Provisional Application having Ser. No. 62/135,555 filed Mar. 19, 2015, which is hereby incorporated by reference herein in its entirety.

### BACKGROUND

The embodiments herein relate generally to systems providing coordination and monitoring of service providers.

Many people desire the services of a butler, chef, personal assistant, or other personal service to assist them in their business or residences but cannot afford the cost of such a service. In addition, it is inherently required that the client be present to allow the service provider into the locale and monitored in case of emergency. So instead, known food preparation services for example allow pre-packaged ingredients to be shipped to the home and relies on the ability of the customer to follow the instructions and prepare the food.

As can be seen, there is a need for a system that allows a client to order services and monitor progress of the service without necessarily being present. Furthermore, there is a need to monitor the availability of the service provider during execution of services to ensure the service provider is not in need of emergency assistance.

### SUMMARY

In one aspect of the subject disclosure, a computer program product for coordinating and monitoring service providers comprises a non-transitory computer readable storage medium having computer readable program code embodied therewith. The computer readable program code is configured to: provide a portal, accessed through a first computing device by a service requester, for services of a service provider to be provided at an event and location of the service requester's direction; receive through the portal from the service requester a selection of the service provider and services to be provided at the location; transmit by a processor of a host server of the portal the location to a second computing device for the service provider; transmit a polling signal at pre-set intervals from the second computing device of the service provider to the host server in response to the service provider arriving at the location; determine by the processor at the host server whether a response signal from the second computing device in response to the polling signal has been received; and in response to a response signal not being received within a pre-set time from the second computing device, the processor in the host server issues an alert to a third party.

In another aspect, a system for coordinating and monitoring service providers comprises a first computing device with an electronic display and transceiver associated with a service requester; a second computing device with an electronic display and transceiver associated with a service provider; and a host server including a processor and a transceiver configured to communicate wirelessly with the transceivers of the first and second computing devices, the processor configured to: provide a portal, accessed through the first computing device computing device by the service requester, for services of the service provider to be provided at an event and location of the service requester's direction; receive through the portal from the service requester a selection of the service provider and services to be provided at the location; transmit by the processor the location to the second computing device for the service provider; transmit a polling signal at pre-set intervals from the second computing device of the service provider to the host server in response to the service provider arriving at the location; determine by the processor whether a response signal from the second computing device in response to the polling signal has been received; and in response to a response signal not being received within a pre-set time from the second computing device, the processor issues an alert to a third party

### BRIEF DESCRIPTION OF THE FIGURES

The detailed description of some embodiments of the invention is made below with reference to the accompanying figures, wherein like numerals represent corresponding parts of the figures.

FIG. 1 is a flowchart of a method of a coordinating and monitoring service providers according to an embodiment of the subject technology.

FIG. 2 is a continuation of the flowchart of FIG. 1.

FIG. 3 is a continuation of the flowchart from point B of FIG. 2.

FIG. 4 is a continuation of the flowchart from point C of FIG. 2.

FIG. 5 is a continuation of the flowchart from point F of FIG. 4.

FIG. 6 is a continuation of the flowchart from point D of FIG. 2.

FIG. 7 is a continuation of the flowchart from point H of FIG. 6.

FIG. 8 is a block diagram of a network according to an embodiment of the subject technology.

### DETAILED DESCRIPTION OF CERTAIN EMBODIMENTS

In general, embodiments of the disclosed invention provide an online portal accessible through computing devices (for example, mobile smartphones, tablets, or wearable devices) which provide for coordination and monitoring of service providers. One who wishes to hire a service provider (for example, a butler/maid or chef) for an event may access the portal and select from a number of providers. Providers have the opportunity to confirm acceptance of an assignment. Aspects of the disclosure allow for example, a service requester to hire someone to clean their house or prepare food at their residence without being present. This provides both convenience and is time efficient for a busy professional with many daily demands. For example, if the requester is hosting a dinner party one evening, the requester may not have sufficient time to handle their work schedule in addition to shopping for food and preparing meals before guests arrive. It is also useful for those individuals that are physically hindered (for example, are home with a medical condition) that wish to minimize oversight of the service provider. As might be appreciated, aspects of the embodiments disclosed also provide safety features associated with the system and services being provided. Allowing a service provider to render services while the requester is remote has inherently risks associated with lack of physical supervision. One aspect of the present invention includes having the service provider affirmatively respond to a request to check in to ensure that the provider is available and has not suffered injury while providing services.

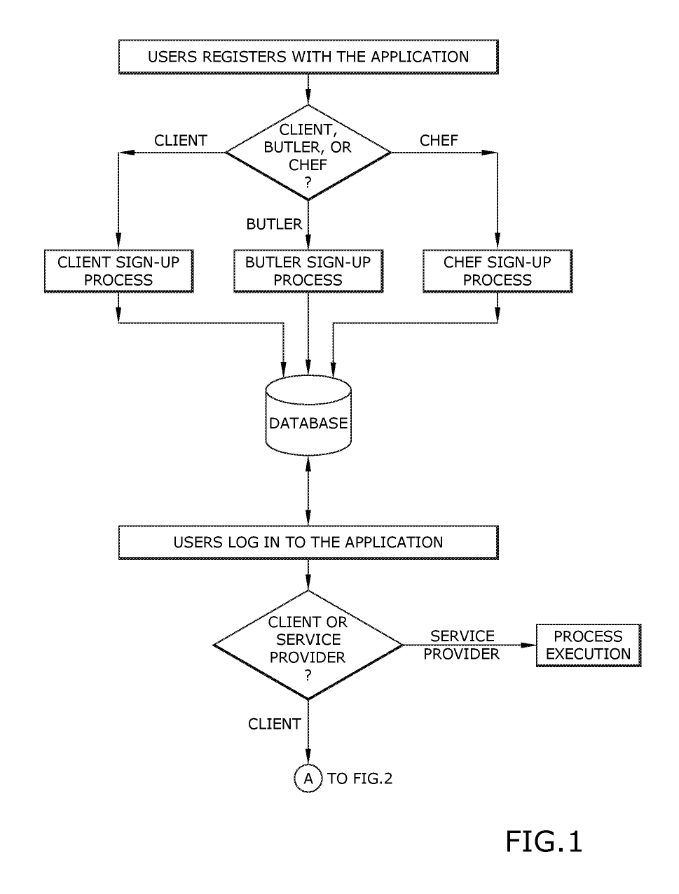

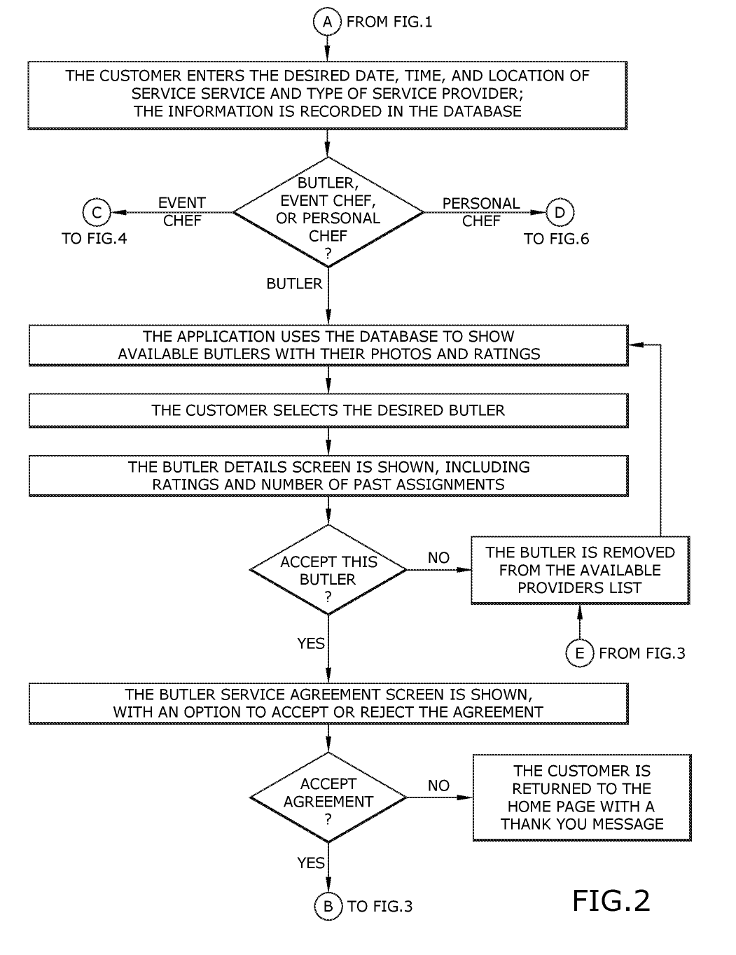

Referring now to FIGS. 1-7 a method of coordinating and monitoring service providers is shown according to an exemplary embodiment of the present invention. The method diverges into processes related to the hiring of a butler, personal chef, and event chef. However, it will be understood that these are examples of services that can be provided and other services may be used/provided in the context of the disclosure without departing from the scope of the invention.

Referring to FIG. 1, users (service requesters and service providers) register an account with the portal through for example a mobile device software application. For service providers, the user may register what type of service they can provide (butler or chef). Or they may indicate they are a client (service requester). Depending on the selection, a sign-up process is performed where information related to the user is entered and stored within a host server database. After registration, a user may return to the portal and may select whether they wish to use the portal as a client requesting services or as a service provider. Service providers will be directed to pending requests/assignments as described further below. Service requesters are directed to the steps that follow.

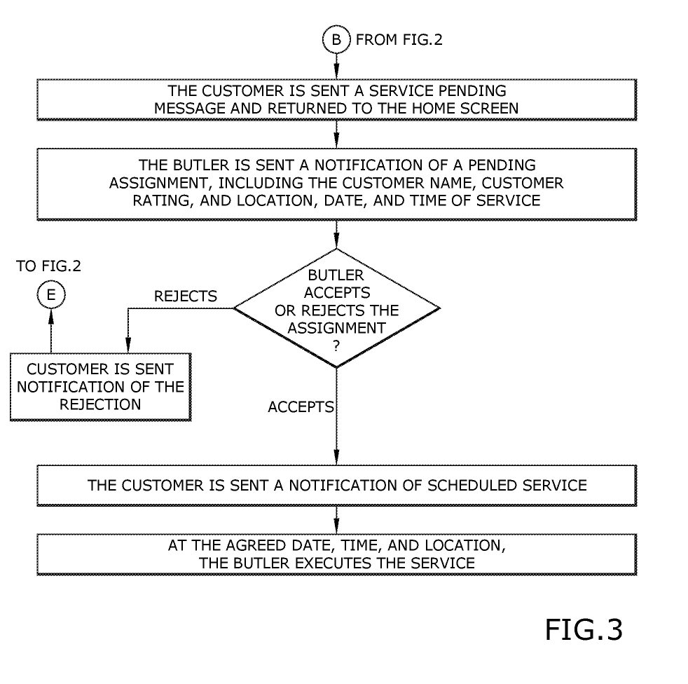

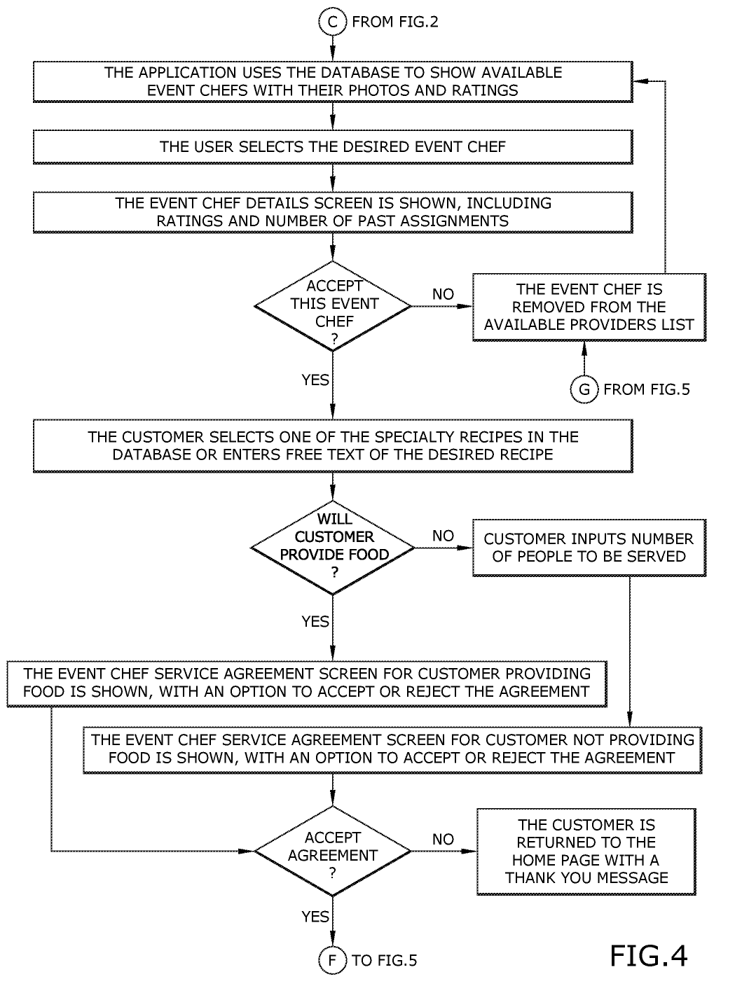

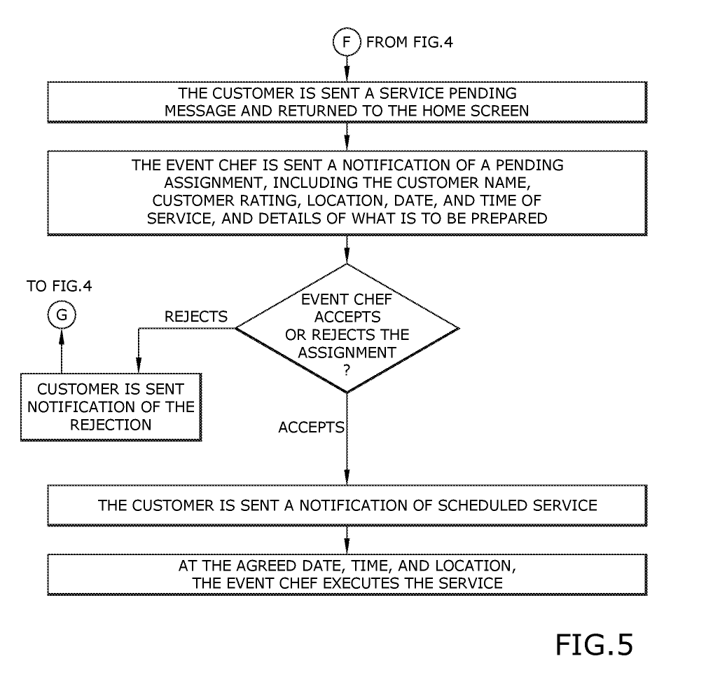

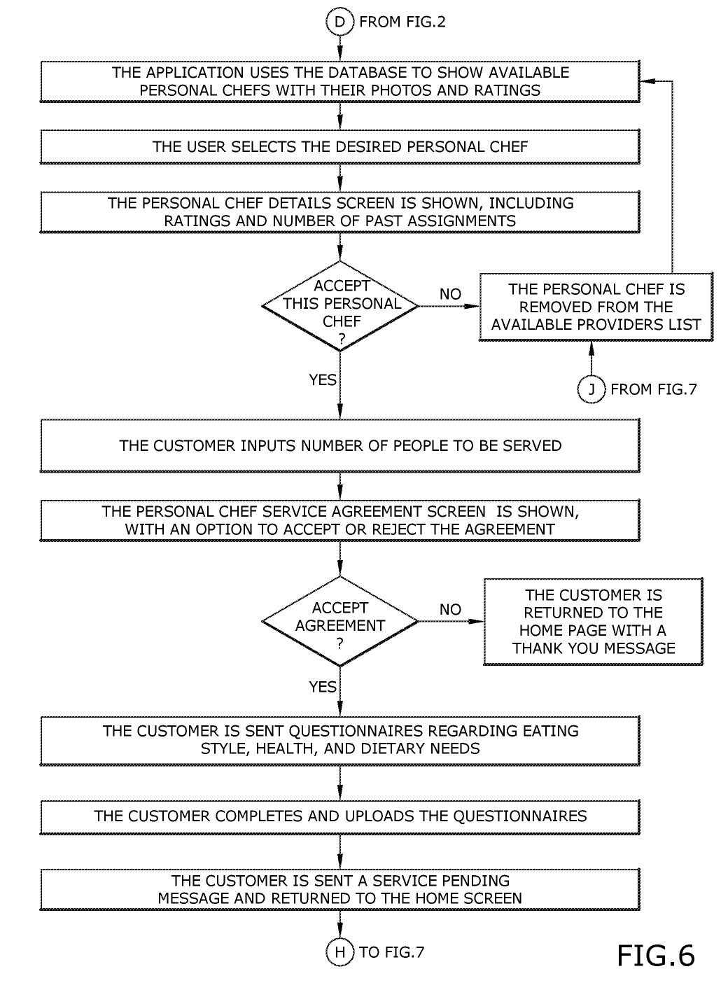

Referring now to FIG. 2, the customer (service requester) enters the desired date, time, and location of service and type of service provider. The information is recorded in the database. A processor in the host server determines the type of service provider needed and searched through the database for the appropriate available candidates. If the request was for a butler, a list of available butlers is displayed on the requester's computing device display along with photographs of the providers and their ratings. The requester makes a selection and details associated with the selected butler including ratings and past assignments is displayed. If the requester does not select the butler candidate for the assignment, the butler candidate is removed from the list and the requester is returned to the list of available candidates. Upon selection of a candidate for an assignment, the requester is shown a service agreement to review, accept or reject. Rejection of the terms of service may return the requester to the homepage. Acceptance of the terms of service may provide the requester with a display showing their request is pending acceptance by the provider. The selected/requested butler is sent a notification of a pending assignment, including the customer name, customer rating, and location, date, and time of service to be performed. If the butler rejects the assignment request, the requester is sent an electronic notification of the rejection in which case the butler may be removed from the list of available candidates and the requester may be returned to the list of remaining available butlers. Acceptance of the assignment may result in the requester being sent a notification of scheduled service.

In an exemplary embodiment, when the service provider leaves for the location, a randomly generated password is generated unique to the event. When the service provider arrives at the location, the client may request that the service provider provide the password. In some cases the requester may be at the location or in some cases, the requester may ask for the password electronically via phone call or messaging. If the password matches with the one in the possession of the requester, the requester may allow the service provider access to the location.

Once the service provider enters the location he indicates entrance on his computing device (smart phone or similar device). A signal is sent back through the network to the database indicating the service has initiated. The butler may then commence services. Based on an interval set by the service provider a signal, or ping, is sent to the service provider's computing device. The service provider must respond to this ping, for example by pressing a key on his computing device within a pre-set time frame. If the service provider does not respond to this ping within a preset time frame, the system may assume there is a safety problem. A system administrator may notify a third party (for example public safety personnel.) that an emergency may exist.

Referring now to FIG. 4, a process is shown related to the request and selection of an event chef in FIG. 2. The process is similar to the process of selecting a butler except that upon acceptance of an event chef, the customer selects one of the specialty recipes in the database associated with the chef or enters free text of a desired recipe(s) for the event. The portal queries whether the requester will provide food for the recipes. If food is not provided, the requester enters in a field the number of expected guests. Once the decision on whether food will or will not be provided by the requester, the requester is provided a service agreement with terms to accept similar to the process in FIG. 2. FIG. 5 shows a process associated with acceptance of the terms of service for the event chef which is similar to the process disclosed in FIG. 3.

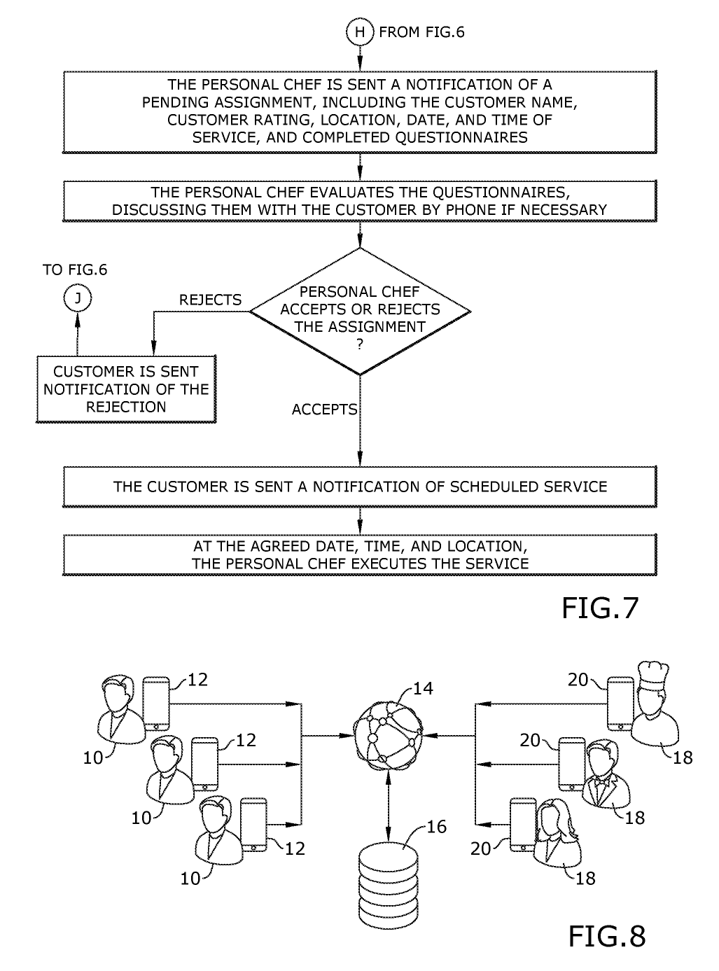

Referring now to FIG. 6, a process is shown related to the request and selection of a personal event in FIG. 2. The process in FIG. 6 is similar to the process shown related to the event chef except that after the step related to acceptance of terms of service, the requester may be electronically sent a questionnaire regarding eating style, health, and dietary needs. The requesters repose to the questions is returned to the host server and provided to the personal chef's account for review. The requester may be provided a pending assignment notice while the personal chef evaluates the requester's profile and responses to the questions. The personal chef may contact the requester to discuss the details related to the responses provided by the requester. The personal chef may then have the option to accept or reject the assignment. If the assignment is accepted, the process continues and is similar to the process disclosed in FIG. 3.

Referring now to FIG. 8, a system embodiment is shown according to an exemplary embodiment of the present invention. The system includes a host server 16 which may include a database and processor for coordinating operation of the portal for coordinating and monitoring service providers as disclosed above. The host server 16 may be an intermediary between requesters 10 and service providers 18 with communication between each element provided through a communications network 14. Interface with the portal by the requesters may be performed via electronic computing device 12. Interface with the portal by service providers 18 may be performed via electronic computing devices 20. The computing devices 12 and 20 and the server 16 may be in the form of a general-purpose computing device. The host server 16 may serve the role as the machine implementing for example the functions of storing service requester and service provider records, providing a user interface platform, providing a web portal for access by users and third parties, sending out notifications of pending assignments, acceptance and rejection of assignments, receiving user input/feedback and ratings, generating passwords, sending polling signals, receiving polling signal acknowledgements, and notifying third parties of failed acknowledgements. The components of the computing devices 12 and 20 and the server 16 may include, but are not limited to, one or more processors or processing units, a system memory, and a bus that couples various system components including the system memory to the processor.

The computing devices 12 and 20 may be for example, tablet devices, mobile telephone devices, wearable computing devices, and handheld or laptop devices. The server 16 may be for example server computer systems, multiprocessor systems, microprocessor-based systems, network PCs, and distributed cloud computing environments that include any of the above systems or devices, and the like. The computing devices 12 and 20 and the server 16 may be described in the general context of computer system executable instructions, such as program modules, being executed by a computer system (described for example, below).

The computing devices 12 and 20 and the server 16 may typically include a variety of computer system readable media. Such media could be chosen from any available media that is accessible by the computer system/server, including non-transitory, volatile and non-volatile media, removable and non-removable media. The system memory could include one or more computer system readable media in the form of volatile memory, such as a random access memory (RAM) and/or a cache memory. By way of example only, a storage system can be provided for reading from and writing to a non-removable, non-volatile magnetic media device typically called a “hard drive” (not shown). The system memory may include at least one program product having a set (e.g., at least one) of program modules that are configured to carry out the functions of embodiments of the invention. The program product/utility, having a set (at least one) of program modules, may be stored in the system memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of embodiments of the invention as described herein. Any combination of one or more computer readable media (for example, storage system may be utilized. In the context of this disclosure, a computer readable storage medium may be any tangible or non-transitory medium that can contain, or store a program (for example, the program product) for use by or in connection with an instruction execution system, apparatus, or device.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for coordinating and monitoring service providers, the computer program product comprising a non-transitory computer readable storage medium having computer readable program code embodied therewith, the computer readable program code being configured to:
provide a portal, accessed through a first computing device by a service requester, for services of a service provider to be provided at an event and location of the service requester's direction;
receive through the portal from the service requester a selection of the service provider and services to be provided at the location;
transmit by a processor of a host server of the portal the location to a second computing device for the service provider;
transmit a polling signal at pre-set intervals from the second computing device of the service provider to the host server in response to the service provider arriving at the location;
determine by the processor at the host server whether a response signal from the second computing device in response to the polling signal has been received; and
in response to a response signal not being received within a pre-set time from the second computing device, the processor in the host server issues an alert to a third party.

2. The computer program product of claim 1, further comprising computer readable program code being configured to:
generate, by the processor in the host server of the portal, a randomly generated password associated with the event; and
transmit the password to the first computing device for the service requester to identify the service provider and transmit to a second computing device for the service provider to provide to the service requester.

3. The computer program product of claim 1, further comprising computer readable program code being configured to generate a map showing a current location of the service provider en route to the location.

4. The computer program product of claim 1, further comprising computer readable program code being configured to transmit a signal to the service requester displaying completion of services by the service provider.

5. A system for coordinating and monitoring service providers, comprising:
a first computing device with an electronic display and transceiver associated with a service requester;
a second computing device with an electronic display and transceiver associated with a service provider; and
a host server including a processor and a transceiver configured to communicate wirelessly with the transceivers of the first and second computing devices, the processor configured to:
provide a portal, accessed through the first computing device computing device by the service requester, for services of the service provider to be provided at an event and location of the service requester's direction;
receive through the portal from the service requester a selection of the service provider and services to be provided at the location;
transmit by the processor the location to the second computing device for the service provider;
transmit a polling signal at pre-set intervals from the second computing device of the service provider to the host server in response to the service provider arriving at the location;
determine by the processor whether a response signal from the second computing device in response to the polling signal has been received; and
in response to a response signal not being received within a pre-set time from the second computing device, the processor issues an alert to a third party.

6. The network of claim 5, wherein the processor is further configured to:
generate a randomly generated password associated with the event; and
transmit the password to the first computing device for the service requester to identify the service provider and transmit to a second computing device for the service provider to provide to the service requester.

7. The network of claim 5, wherein the processor is further configured to generate a map showing a current location of the service provider en route to the location.

8. The network of claim 5, wherein the processor is further configured to transmit a signal to the service requester displaying completion of services by the service provider.
